(19) United States
(12) Patent Application Publication
(10) Pub. No.: US 2022/0076489 A1
(43) Pub. Date: Mar. 10, 2022

(54) SYSTEMS AND METHODS FOR GENERATING SUPPLEMENTAL CONTENT IN AN EXTENDED REALITY ENVIRONMENT

(71) Applicant: Rovi Guides, Inc., San Jose, CA (US)

(72) Inventors: Ajay Kumar Mishra, Bangalore (IN); Jeffry Copps Robert Jose, Chennai (IN)

(21) Appl. No.: 17/014,309

(22) Filed: Sep. 8, 2020

(51) Int. Cl. G06T 19/00; G06K 9/00; G06K 9/62; G06T 7/70

(52) U.S. Cl. CPC G06T 19/006; G06K 9/00624; G06K 9/6228; G06T 7/70; G06K 9/6215

(57) ABSTRACT

Systems and methods are disclosed herein for presenting supplemental content in an extended reality (XR) environment. The system may receive fields of view of an XR environment and generate a data stream representing the fields of view, the data stream comprising, for each field of view, a data structure including at least one object identifier corresponding to a visual item appearing on the respective field of view, and field coordinates representing the position of the field of view in the XR environment. The system may compute an importance score using an occurrence number of the object identifier and a view change rate using the field coordinates. In response to the importance score exceeding an importance threshold, the system generates instructions for displaying in the XR environment supplemental content, related to the visual item.

### BACKGROUND

The present disclosure is directed to techniques for improved generation of supplemental content in extended reality environments, and more particularly to improved techniques for providing supplemental content by identifying which visual items, in a field of view of an extended reality environment, may correspond to an object of interest for a user.

### SUMMARY

Extended reality (XR) environments include all real and virtual combined environments, including virtual reality (VR), augmented reality (AR), mixed reality (MR) and any other realities in between. XR systems may include wearables, such as an XR head-mounted device, comprising, for instance, a stereoscopic display, or smart glasses.

In one approach, supplemental content providers may use several technologies and algorithms to display supplemental content in XR environments. For example, an XR reality system may identify the demographics category to which the average user (or viewer) belongs and may display supplemental content relevant for that demographics category. To provide more personalized content, XR reality system may use algorithms that take into account the user watch history, and/or watch patterns. For instance, during a football match, a banner (which is a type of supplemental content) may appear on a screen, next to the score or in a predetermined position (e.g., the lower left-hand corner).

However, the relevance of the banner to the user and interaction between such banner and the user may be low for different reasons: for instance, the user might be focused on the ball or on a specific player and might overlook the banner. In another example, the user may not be interested in the score at all, and thus a banner next to the score may be wholly irrelevant. For this reason, the aforementioned approaches may fail to correctly identify objects of interests for which the supplemental content is likely to be relevant or effective.

Displaying supplemental content at an ineffective location in an XR environment may therefore clutter the screen with unnecessary images, obscure relevant parts of the XR environment, and waste computational resources needed to render and display the supplemental content. Moreover, such supplemental content at an ineffective location may be of little interest for the supplemental content provider and may degrade user interface and negatively impact experience. In some situations where supplemental content is displayed at an inappropriate location, the user may even actively attempt to avoid or delete the irrelevant supplemental content.

Accordingly, to solve these problems, techniques are disclosed herein for improving the presentation of supplemental content in an XR environment. For example, an XR system receives a raft of fields of view, at a respective time position, corresponding to what is displayed for the user's consumption in the XR environment. In this regard, an XR environment may comprise a 360 degree environment and each field of view represents a portion only of the whole XR environment.

Based on those fields of view, the XR system generates a data stream. The data stream comprises, for each field of view, a respective data structure that includes a list of object identifiers, each object identifier corresponding to a visual item that appears in the field of view. The data structure also includes the position (e.g., field coordinates) of the field of view in the XR environment (e.g., a 3D cone cutting out a certain solid angle in a full 360 sphere environment, or more simply “−25 deg, +45 deg” in a simple 360 degree environment). The data structure may include a list of objects, each object including the object identifier and other elements of information related to the visual item. Using that data stream, the XR system calculates an occurrence number of every object ID in the data stream. For example, the XR reality system may calculate the number of data structures in which a same object ID appears (that is to say the number of fields of view on which a same visual item appears). In addition, the XR system calculates a view change rate of the field coordinates of the fields of view (e.g., a measure of variance of field coordinates) in the XR environment for all the data structures in which the same object ID appears, that is to say for all the fields of view in which the same visual item appears.

In this way, the XR system uses the data stream, obtains information corresponding to how often or how long the visual item appears in the XR environment and how much the user is trying to follow the visual item. For instance, in a situation where the XR environment contains a moving car item in a user's field of view at a first time and where the XR environment contains the same moving car item in a different field of view at a second time, the XR reality system may infer that the user turned around to follow the car item. The XR system's evaluation of the importance of the car item may increase the more times the same car item appears in the user's fields of view at different times and the faster the user's fields of view change.

In this case, the occurrence number illustrates that the car can be found on both fields of view and the value of the view change rate is high (180 degrees between two images). Based on the occurrence number and the view change rate, the XR system computes an importance score, to capture the importance of the visual item for the user. For instance, if an occurrence number is high and the value of the view change rate is high, the XR system may infer that the user has been actively looking at an item for a substantial amount of time, and the XR system will accordingly compute a high importance score. Conversely, if an occurrence number is low, the XR system may infer that the user accidentally looked at the item or that the item did not catch the user's attention. The XR system will accordingly compute a low importance score. In order to make sure that supplemental content uses the resources efficiently, the XR system may consider only objects seen as objects of interest (associated with an item of interest) for the display of supplemental content. For example, when the item of interest is a car, supplemental content may be data related to the car, such as informational content or commercial content (e.g. “purchase that car on www.buythatcar.com”). To sort an object of interest from the rest, the XR system compares the importance score to a threshold. When the importance score is above the threshold, the XR system generates instructions for displaying supplemental content in the XR environment. The supplemental content may be related to the visual item of interest corresponding to the object identifier of the object of interest or it may be independent. Objects whose scores are below the threshold have not attracted (or are not attracting or will not attract) sufficient attention from the user.

With such a technique, a supplemental content provider, by means of the XR system, may have access to further information about the item that the user is watching. This can enable the XR system to avoid displaying supplemental content at an ineffective time and/or at ineffective locations and, thus to avoid waste of computing resources. The computation of the score also allows a multiparametric approach and enables ranking several objects of interest. The supplemental content providers may thus build a content strategy to optimize the computing resources (in terms of environmental footprint and financial costs), as well as the visibility and the interaction between the user and the supplemental content. Furthermore, the identification of an object of interest increases the chance of interaction between the supplemental content and the user, as less but more relevant supplemental content may be displayed. Overall, the XR environment is improved for the user and the performance of the XR system is optimized.

In addition, the generation of the data stream, which contains all the relevant information for further calculation and computation, is a powerful and easily handled tool. The data stream enables a computing device used to generate the data stream to delegate some of the computational tasks to another computing device. As the data stream may encompass only strings and numbers, its size makes it easy to be forwarded and manipulated.

In some embodiments, to avoid getting false positives such as a visual item moving along with the fields of view but without any intention from the user to follow the visual item, the score may be computed only if the item appears at least on a predetermined number of fields of view.

In some embodiments, the more the field coordinates of the fields of view on which the same item appears vary, the higher the importance score. It may be inferred that the user is actively following the item, which means that he or she is substantially focused on the item. The associated object is therefore a valuable object of interest for supplemental content.

In some embodiments, to improve the relevance of the supplemental content and, hence, its interactions with the user, and to increase the added value of both the data stream and the content strategy from the supplemental data providers, the data stream may comprise one or more features of the object corresponding to the item and the features are used in the calculation of the importance score. For instance, between a car and a tractor, the user is more likely to relate to the car. The importance score may therefore take into account the occurrence number, the view change rate and the features of the object. For example, different features (e.g., features listed in a data structure describing the object) may positively or negatively affect the importance score. The way they affect the importance score may be defined in a function of a user's profile. An object with a low-interest feature for a regular user, such as a tractor for an accountant, may still lead to a score being above the threshold if the user is watching it at length and/or actively following it in the XR environment. Conversely, an object with a high-interest feature for a regular user, such as a garment, may lead to a score being above the threshold as well even if the user only briefly looked at it.

In some embodiments, to improve the identification of objects corresponding to a visual item that the user is actively observing, the data stream may comprise the coordinates of the visual item in the field of view in the XR environment. Based on those data, the XR system may compute an object movement rate that illustrates the change rate of the coordinates of the visual item within the fields of view. For instance, in the previously mentioned situation where a field of view contains a car and where another field of view, captured after the user has turned around, still contains the same car, the view change rate of the car may indicate a level of attention from the user. If the object movement rate is close to zero, this means that the car remained at the same location in two different fields of view (e.g., the center of the field of view). The XR system may infer that the user kept the item in a central visual field of his or her eyes and that the object associated with the item is an object of (high) interest.

In some embodiments, the XR system processes at least two objects in two rafts of fields of view which share a certain number (e.g., half) of the fields of view (e.g., the first raft has 25 fields of view and the second raft has 35 fields of view, amongst which 13 are also in the first raft). It is thus a situation in which there might be a competition and displaying supplemental content for both objects might be counterproductive (user being overwhelmed or frustrated by the amount by supplemental content, user's attention divided in half, lack of computational resources, etc.). Therefore, the XR may compare both importance scores and choose only the object with the higher score of the two to generate supplemental content.

### BRIEF DESCRIPTION OF THE DRAWINGS

The below and other objects and advantages of the disclosure will be apparent upon consideration of the following detailed description, taken in conjunction with the accompanying drawings, in which:

FIG. 1 shows an illustrative diagram for presenting supplemental content, based on computing an importance score, in accordance with some embodiments of the disclosure;

FIG. 2 shows an illustrative block system diagram, in accordance with some embodiments of the disclosure;

FIG. 3 shows an illustrative partial view of a block system diagram, in accordance with some embodiments of the disclosure;

FIG. 4 is an illustrative flowchart of a process for displaying supplemental content, in accordance with some embodiments of the disclosure;

FIG. 5 is an example diagram illustrating a data stream, in accordance with some embodiments of the disclosure;

FIG. 6 is an illustrative flowchart of a process to deal with a competition of objects, in accordance with some embodiments of the disclosure;

FIG. 7a and FIG. 7b provide an illustrated situation, in accordance with some embodiments of the disclosure;

FIG. 8a and FIG. 8b provide an illustrated situation, in accordance with some embodiments of the disclosure;

FIG. 9a and FIG. 9b provide an illustrated situation for the display, in accordance with some embodiments of the disclosure;

FIG. 10 provides an example diagram of a bidding war, in accordance with some embodiments of the disclosure.

### DETAILED DESCRIPTION

Accordingly, systems and methods are described herein for presenting supplemental content to a user's extended reality (XR) experience. In particular, systems and methods are presented herein for generating instructions to display supplemental content in relation to a visual item in a field of view in an augmented reality (AR) device.

An XR set, such as an AR or virtual reality (VR) headset, smart glasses, or a portable device with a camera and an AR application, such as a mobile phone, smartphone or tablet, may be used to display an XR environment to a user (also called a viewer). A field of view is a portion of the XR environment that is presented to the user at a given time by the XR set (e.g., an angle solid in a full 360 sphere environment). In the case of a VR set, a field of view typically consists in a pair of 2D images to create a stereoscopic view; in the case of an AR set (e.g., smart glasses), a field of view typically consists in 3D or 2D images which may include a mix of real objects and virtual objects overplayed on top using the AR set (e.g., for smart glasses, a picture captured with a camera and content added by the smart glasses). If an XR environment has a single degree of liberty, say a rotation of 360 degrees, any field of view may be defined by either the edge angular coordinates (e.g. +135 degree, +225 degrees) or by a single angular coordinate (e.g., −55 degree) combined with the known angular opening of the field of view. If an XR environment has six degrees of liberty, say three rotations of 360 degrees and three spatial positions, any field of view may be defined by three angular coordinates and three spatial coordinates. A field of view is therefore a portion of the XR environment that the XR set displays when the user is at a particular location in the XR environment and has oriented the XR set in a particular direction.

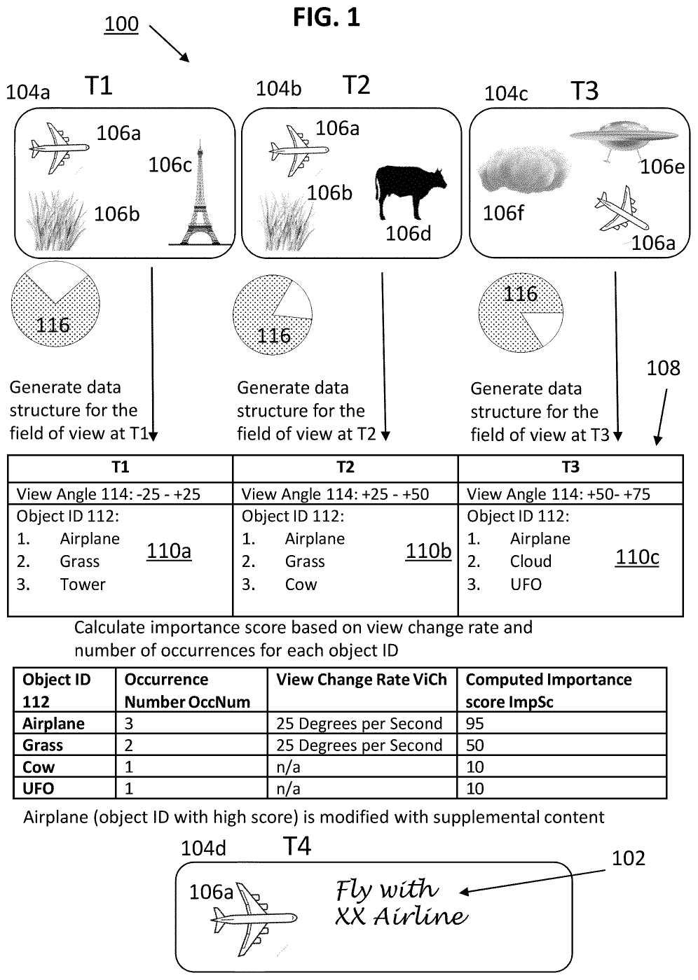

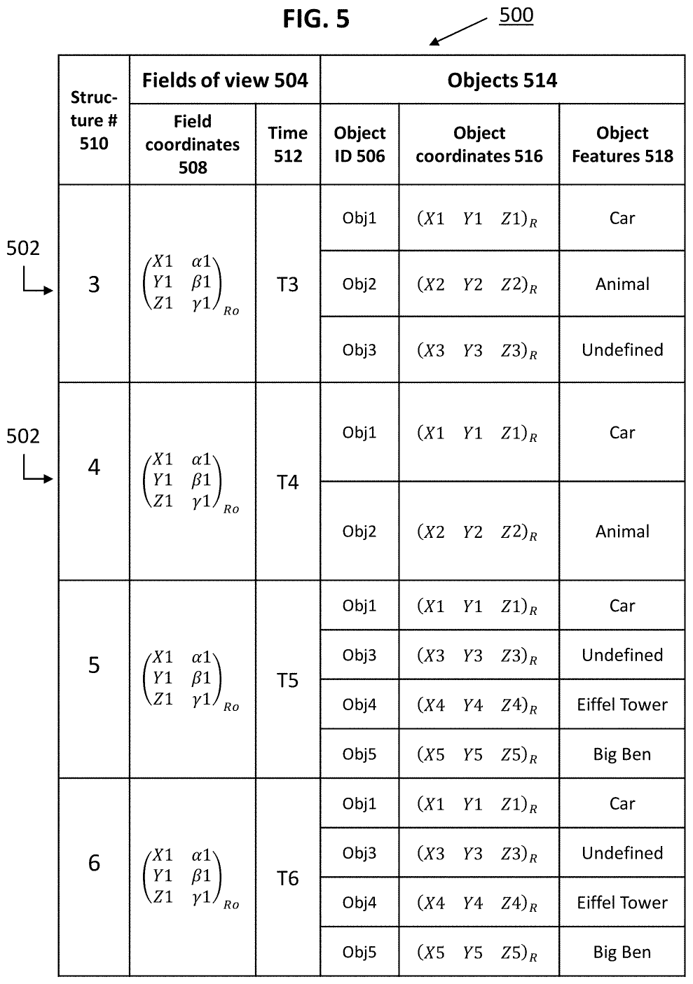

FIG. 1 shows an illustrative diagram 100 for presenting supplemental content 102 based on an importance score, in accordance with some embodiments of the disclosure. A data stream engine may receive a plurality of fields of view 104a, 104b, 104c of an XR environment being displayed, or displayed and captured, by an XR set. The data stream engine may run on an XR system. Each of the fields of view 104a, 104b, 104c has been captured at a different time position T1, T2, T3, which may correspond to successive frames or a selection of frames (captured or generated), in order to process fewer data. A frame is defined in relation with the XR environment and may therefore refer to a 2D environment or a full 3D environment. Each of fields of view 104a, 104b, 104c includes at least one visual item 106: plane 106a, grass 106b, tower 106c, cow 106d, UFO 106e, sun 106f, for instance. The data stream engine generates a data stream 108 representing the plurality of fields of view 104a, 104b, 104c. The data stream 108 may include, for each field of view 104a, 104b, 104c, a respective data structure 110a, 110b, 110c. A data structure 110a, 110b, 110c may include at least one object identifier (ID) 112 that is associated with a visual item 106 appearing in the respective field of view 104a, 104b, 104c. As illustrated in FIG. 1, the object identifier 112 may be a label describing the visual item 106 or a number or any combination of alphanumerical characters. For every visual item 106, the data stream engine attributes a single identifier 112 to it, to avoid any confusion: if a same visual item 106 appears on two fields of view 104a, 104b, the data stream engine may attribute the same object identifier 112 (see visual item 106a in fields of view 104a, 104b, 104c whose object identifier is “airplane” in data structures 110a, 110b, 110c, for instance). A data structure 110a, 110b, 110c may further include field coordinates 114 that represent the position of the respective field of view 104a, 104b, 104c in the XR environment associated with the respective data structure 110a, 110b, 110c. In the simplified illustration of FIG. 1, the field coordinates 114 are a pair of angular coordinates (called “view angle” in FIG. 1). More complex angle definitions, in a full 3D XR environment, will be described below in relation to FIG. 5. The field coordinates 114 are also illustrated by means of diagram 116 that represents which part of the XR environment is being covered by the field of view 104a, 104b, 104c. Field coordinates 114 that change between two fields of view 104a, 104b, 104c usually mean that the user has at least moved his or her head, to which the XR headset is attached (either walked, moved or rotated his or her head), or moved (either physically or in the XR environment by means of a controller, for instance). The data stream 108 may therefore include a plurality of data structures 110a, 110b, 110c that reference, by means of object identifiers 112, visual items 106a, 106b, 106c, 106d visible on the fields of view 104a, 104b, 104c and the field coordinates 114 of the fields of view 104a, 104b, 104c. Typically the data stream 108 is a file generated by the data stream engine, using the XR system. The data stream engine, using the XR system, then stores the file in a memory.

Using the data stored in data stream 108, an occurrence engine may calculate, for each object identifier 112, a number of data structures 110a, 110b, 110c of the data stream 108 in which a same object identifier 112 appears. The result of the calculation is called an occurrence number (OccNum) and the object identifier is called a candidate object identifier. It therefore corresponds to a same visual item that appears on different fields of view. For instance, for object identifier 112 “airplane” corresponding to visual item 106a, the occurrence number is three, as the visual item 106a appears on fields of view 104a, 104b, 104c; for object identifier “cow” attributed to visual item 106d, the occurrence number is one, as the visual item 106d appears on field of view 104b only. Still using data stored in data stream 108, a position engine may calculate, for each candidate object identifier 112, a measure of variance of field coordinates for the data structure in which the candidate object appears. The result of the calculation is called a view change rate (ViCh). The view change rate ViCh quantifies the evolution of the position between two fields of view 104a, 104b, 104c on which the same visual item 106 appears. The view change rate ViCh may vary amongst a plurality of fields of view; therefore, the view change rate ViCh may be a set of values instead of one value or an interval of values. The view change may alternatively be an average value.

Based on the occurrence number OccNum and the view change rate ViCh, a score engine may compute an importance score (ImpSc). The importance score ImpSc may be positively correlated with the occurrence number OccNum and/or the view change rate ViCh. The importance score ImpSc may be computed using the following formula: ImpSc=A.OccNum+B.ViCh where A and B are ponderation coefficients (e.g. positive integers), determined in the function of the importance that an operator wants to grant to the different parameters.

A comparison engine then compares the importance score ImpSc to a threshold, called importance threshold (ImpTh) (e.g., a positive integer, such as 80, 90 or 100). If the comparison engine determines that the importance score ImpSc exceeds the importance threshold ImpTh, an instruction engine may generate instructions for displaying supplemental content in the XR reality environment. The supplemental content may be related to the visual item corresponding to the candidate object identifier. Alternatively, the supplemental content may be entirely independent from that visual item. Following the generation of the instructions, a displaying engine, upon reception of the instructions, then displays supplemental content in the XR environment using the XR set. For instance, in FIG. 1, the importance score ImpSc of candidate object identifier 112 “airplane” was above the threshold (e.g. importance threshold ImpTh of 80) and, in a fourth field of view 104d at a time T4, supplemental content 102 is displayed in the XR environment by means of an XR set. The supplemental content 102 may be displayed until the visual item is no longer present on a field of view. Alternatively, the supplement content 102 may be residually displayed after the visual item has disappeared from the field of view. A minimal duration may be defined by the displaying engine, such that the user has the opportunity to look at and understand the supplemental content. For instance, the minimal duration may be two seconds.

In an embodiment, the displaying engine may display supplemental content over or next to the visual item to which the candidate object identifier corresponds. If the visual item is moving within the field of view, the displaying engine may move the supplemental content accordingly. In another embodiment, the displaying engine may display supplemental content on a fixed location within the field of view (e.g. the lower left-hand corner). In yet another embodiment, the displaying engine may display supplemental content in an empty area of the field of view, that is to say an area where no visual item is detected. The method can be carried out in real time, with live fields of view. Timewise, the time period between the reception of the plurality of fields of view and the display may be between X second and Y seconds, where X is between 1 s and 5 s and Y is comprised between 10 s and 30 s.

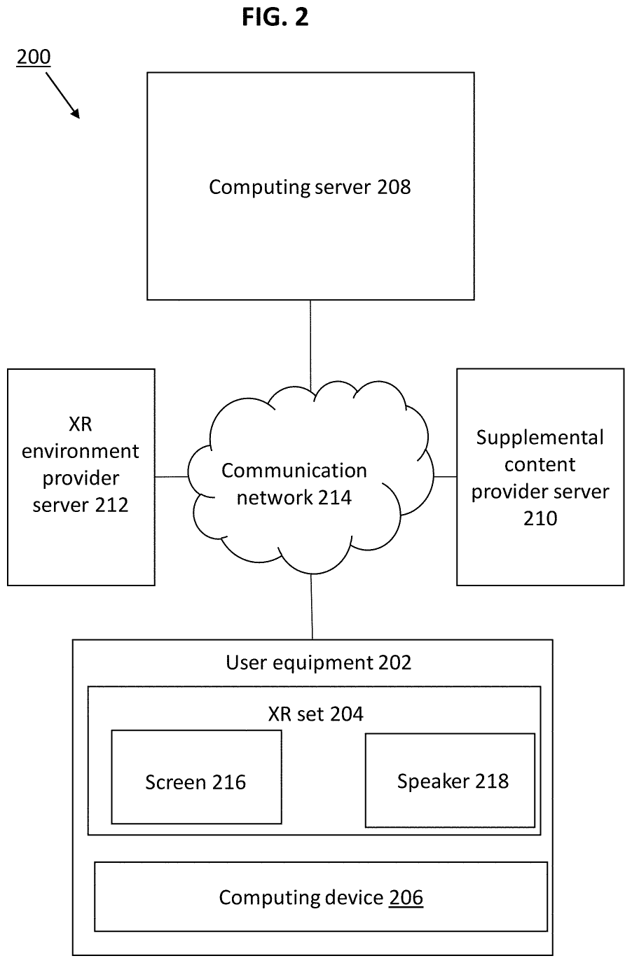

FIG. 2 shows an illustrative system diagram 200 used in relation with FIG. 1. System 200 includes user equipment 202 that includes an XR set 204 and a computing device 206, linked together (with wires or wirelessly). The XR set 204 and the computing device 206 may be a single device. System 200 further includes a computing server 208 and a supplemental content provider server 210. The computing server 208 and the supplemental content provider server 210 may be the same server. Depending on how the XR environment is generated, an XR environment provider server 212 may be part of the system 200 (e.g. cloud gaming). The user equipment 202, the computing server 208, the supplemental content provider server 210 and, if applicable, the XR environment provider server 212, are in communication with one another by means of a communication network 214, such as the Internet. The XR set 204 is used to display (for VR for instance) or to capture and display (for AR, for instance) the fields of view. To this end, the XR set 204 typically includes a screen 216, to display fields of view, and speaker 218, to emit sounds. System 200 may include more elements but FIG. 2 illustrates a simplified view.

The data stream engine, the occurrence engine, the position engine, the score engine, the comparison engine, the instruction engine and the displaying engine (and any other engine defined in the description) may be software tools implemented in the computing device 206 of the user equipment or in the computing server 208. Those engines may be a single application that is performed when a processor executes instructions stored in a non-transitory memory. Alternatively, the engines may be distributed over the different elements of system 200. For instance, the data stream engine may be implemented on the computing device 206 of the user equipment 202; the occurrence engine, position engine, score engine, comparison engine, instruction engine may be implemented on the computing server 208; and the displaying engine may be implemented on the computing device 206 of the user equipment 202. The instruction engine may solicit the supplemental content provider server 210 to provide the supplemental content that is to be displayed. Alternatively, the supplemental content provider server 210 may have been previously solicited and supplemental content may have been stored, so that the instruction engine itself can select the supplemental content.

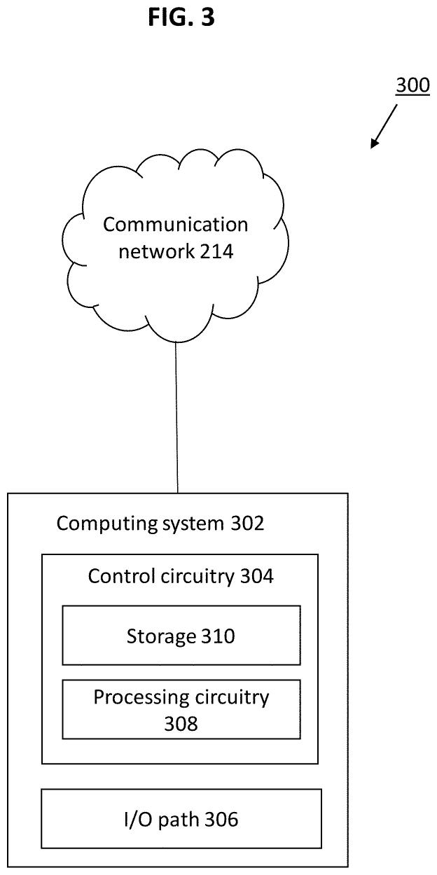

FIG. 3 shows an illustrative block diagram 300 of a computing system 302 connected to communication network 214. The computing system 302 may be the user equipment 202 (or only the computing device 206), the computing server 208, the supplemental content provider server 210, or the XR environment provider server 212, in accordance with some embodiments of the disclosure. In some embodiments, the computing system 302 may be communicatively connected to a user interface. In some embodiments, the computing system 302 may include control circuitry 304 and an input/output (I/O) path 306. Control circuitry 304 may include processing circuitry 308, and storage 310 (e.g., RAM, ROM, hard disk, removable disk, etc.). I/O path 306 may provide device information, or other data, over a local area network (LAN) or wide area network (WAN), and/or other content and data to control circuitry 304, which includes processing circuitry 308 and storage 310. Control circuitry 304 may be used to send and receive commands, requests, signals (digital and analog), and other suitable data using I/O path 306. I/O path 306 may connect control circuitry 304 (and specifically processing circuitry 308) to one or more communications paths.

Control circuitry 304 may be based on any suitable processing circuitry such as processing circuitry 308. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a content improvement engine stored in memory (e.g., storage 310).

Memory may be an electronic storage device provided as storage 310, which is part of control circuitry 304. Storage 310 may store instructions that, when executed by processing circuitry 308, perform the functionality of the engines defined in the present description. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

The computing system 302 may be coupled to communication network 214. The communication network may be one or more networks including the Internet, a mobile phone network, mobile voice or data network (e.g., a 5G, 4G or LTE network), mesh network, peer-to-peer network, cable network, or other types of communication network or combinations of communication networks. The content improvement engine may be coupled to a secondary communication network (e.g., Bluetooth, Near Field Communication, service provider proprietary networks, or wired connection) to the selected device for generation for playback. Paths may separately or together include one or more communications paths, such as a satellite path, a fiber-optic path, a cable path, a path that supports Internet communications, free-space connections (e.g., for broadcast or other wireless signals), or any other suitable wired or wireless communications path or combination of such paths.

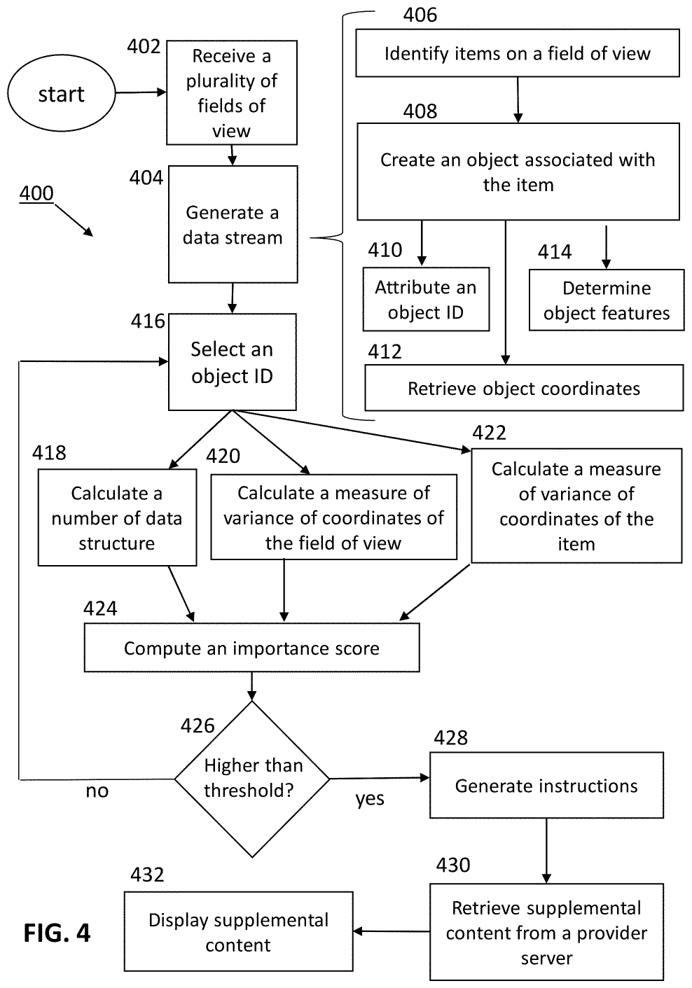

FIG. 4 is an illustrative flowchart of a process for improving display of supplemental content, in accordance with some embodiments of the disclosure. Process 400, and any of the following processes, may be executed by control circuitry 304 (e.g., in a manner instructed to control circuitry 304 by any of the engines described herein). Control circuitry 304 may be part of user equipment 202, computing server 208, XR environment provider server 212, or may be scattered between those entities, which communicate by way of the communication network 214.

At 402, control circuitry 304, when executing the data stream engine, receives a plurality of fields of view of the XR environment, wherein each field of view of the plurality of fields of view was captured at a different time position. Control circuitry 304 retrieves the fields of view via the I/O path 306 from an XR environment source, which may be the computing device 206 of the user equipment 202 and/or the XR environment provider server 212 (e.g. cloud gaming). The source may also be a combination of computing device 206, which retrieves images captured by the XR set 204 and computing device 206 or XR environment provider server 212 (in particular for an AR environment).

At 404, control circuitry 304, when executing the data stream engine, generates a data stream. The data stream is aimed at representing the plurality of fields of view. A data stream 500 is illustrated in FIG. 5. The data stream 500 includes a respective data structure 502 for each of the fields of view 504. Each respective data structure 502 includes at least one object identifier 506 (Obj1, Obj2, etc.) corresponding to a visual item appearing in a respective field of view 504 of a plurality of fields of view. Also, each respective data structure 502 includes field coordinates 508, representing the position of the respective field of view 504 in the XR environment. The field coordinates 508 may include spatial coordinates X1, Y1, Z1 in a fixed reference frame Ro (to spatially locate the user in the XR environment) and angular coordinates α1, β1, γ1 in a fixed reference frame Ro (to angularly locate the field of view in the XR environment). The field coordinates may be a subset of those 6 coordinates or a combination thereof, dependent on the nature of the XR environment, for instance. Control circuitry 304, when executing the data stream engine, may retrieve the field coordinates 508 from the XR environment provider server 212 or from the user equipment 202. Alternatively, sensors mounted on the XR set 204, such as an accelerometer(s), location device, etc., may obtain data enabling determining the field coordinates. In addition, control circuitry 304, when executing the data stream engine, may attribute a number 510 to each data structure 502 to identify it in a unique way. The data structure may also include a time position or time stamp 512 (T1, T2, T3, etc.) of the respective field of view 504. The time stamp 512 may be an absolute time (for instance a GMT time) or a relative time (e.g. in hours, minutes, seconds). Alternatively, the time stamp is a unitless number giving information about the number of the field of view (for instance, two successive numbers indicate that the fields of view were captured successively or with a predetermined step therebetween—e.g., every five or ten fields of view, etc.). Control circuitry 304, when executing the data stream engine, may store the data stream 500 and its data in storage 310.

More precisely, control circuitry 304 generating a data stream, at 404, may include control circuitry 304 identifying, at 406, visual items in the field of view 504 and creating, at 408, an object 514 associated with each visual item identified. Control circuitry 304 may identify a visual item, at 406, using image recognition techniques: control circuitry 304, when executing data stream engine, receives an image and identifies visual items thereon. Alternatively, control circuitry 304 may identify a visual item, at 406, using data received from an XR environment source about the simulated part of the XR environment: control circuitry 304 may receive a list of visual items being display in each field of view 504. In an embodiment, for each field of view 504, control circuitry 304 identifies as many objects 514 as there are visual items. A size threshold may be defined to avoid identifying too many objects. Once control circuitry 304 has created the object 514, at 408, control circuitry 304 attributes, at 410, an object identifier (ID) 506 for the object 514 corresponding to the visual item. The attribution of the object identifier 506 is performed following at least these two rules: a same visual item appearing on several fields of view has the same object identifier, and two different visual items have two different object identifiers. To determine that a visual item is the same on different fields of view, control circuitry 304 may also use image recognition techniques. In an embodiment, for each object, control circuitry 304 may retrieve, at 412, object coordinates 516 corresponding to the position of the visual item in the field of view 504. The object coordinates 516 may be spatial coordinates X1, Y1, Z1, in the reference frame R attached to the field of view, and also angular coordinates, in the same reference frame R. However, in the embodiment of the data stream illustrated in FIG. 5, the angular coordinates are ignored (that is to say that the rotation of the visual item in the XR environment is not taken into account). Control circuitry 304 may compute the object coordinates 516 based on the identification, at 406, of the visual item (for instance, the position of a visual item in a 2D image, which is a projection of a 3D XR environment, so that only two of the three spatial coordinates are used). Alternatively, control circuitry 304 may obtain the object coordinates 516 directly from the XR environment source, for instance along with the list of visual items as disclosed previously. In an embodiment, control circuitry 304 attributes, at 414, for each object at least one object feature 518. Object feature 518 represents a feature of the visual item or a nature thereof. It is typically metadata that describes the visual item that appears in the field of view. For instance, an object feature may be “car”, “animal”, “Eiffel Tower”, “Big Ben”, “plane”, “undefined”, etc. An object 514 may be a computer file storing the object ID 506, the object coordinates 516 and the object features 518. Alternatively, an object 514 is an aggregation of those previous data, stored in a file.

At 416, control circuitry 304, when executing a selection engine, selects an object identifier 506 of the data stream 500. At 418, control circuitry 304, when executing an occurrence engine, calculates a number (called occurrence number OccNum) of data structures 502 of the data stream 500 in which a same object identifier 506, called a candidate object identifier, appears. In an embodiment, only successive data structures 502 in which the object identifier 506 appears are considered for such calculation. In another embodiment, only data structures 502 whose time stamps 512 are close to each other (for instance, all falling within a period of 5 s or 10 s) are considered. The calculation of the occurrence number OccNum typically entails incrementing a box every time a data structure 502 comprises the candidate object identifier 506. At 420, control circuitry 304, when executing a position engine, calculates a measure of variance of field coordinates 508 for the data structures 502 in which the candidate object identifier 506 appears (called view change rate ViCh). This calculation may be a time derivative of the field coordinates. Control circuitry 304 may therefore use the field coordinates 508 and the time stamp 512 of the appropriate data structures 502 to perform such calculation. All the fields of view may be considered, in order to generate a continuous (or quasi-continuous) view change rate ViCh. Alternatively, to limit the amount of data to process, only certain fields of view may be used (one field of view every F fields of view, where F is a positive integer higher than or equal to 2). Only certain field coordinates 508 may be used to compute the view change rate ViCh, such as the angular coordinates. As already discussed, the view change rate ViCh gives an indication about the movement of the field of view (either the user walking or running in the XR environment or moving his or her head on which the headset is mounted). In addition, in an embodiment, at 422, control circuitry 304, when executing a position engine, may calculate a measure of variance of the object coordinates 516 (called object movement rate ObMov), that is to say of the coordinates of the visual item in the field of view. The object movement rate ObMov represents the speed at which the objects move within the field of view. This value is independent from the movement of the field of view. If the XR set 204 is following a visual item moving in the XR environment, the view change rate ViCh will be non-zero, while the object movement rate ObMov will be zero.

Steps 418, 420, 422 may be performed sequentially or in parallel.

At 424, control circuitry 304, when executing a score engine, computes an importance score ImpSc for the candidate object identifier that was selected at 416 and for which its occurrence number OccNum and the view change rate ViCh were calculated—and, if applicable, the object movement rate ObMov. The importance score may be defined by the following formula: ImpSc=A.OccNum+B.ViCh where A and B are ponderation coefficients (e.g. positive integers, or positive real numbers). For instance, the calculated OccNum may be 25 (25 fields of view), the calculated ViCh may be 3 (3 rad/s) and A may be chosen as 2 (2/1 field of view) and B may be chosen as 15 (15/1 rad), such that ImpSc (unitless) is: ImpSc=25×2+3×15=95. The values of A and B therefore allow an operator to arbitrate between the occurrence number OccNum and the view change rate ViCh. In an embodiment, the higher the OccNum, the higher the importance score and/or the higher the ViCh, the higher the importance score. A high importance score denotes a visual item (and its associated object) that presents a strong attraction to the user.

In an embodiment, the importance score ImpSc may be negatively correlated with the view change rate ViCh when the latter is above an upper limit. In other words, the importance score ImpSc may decrease if the ViCh increases above the upper limit (all other things being equal). This allows taking into account a situation where the XR set is moving too fast: the user would not be able to interact with the supplemental content.

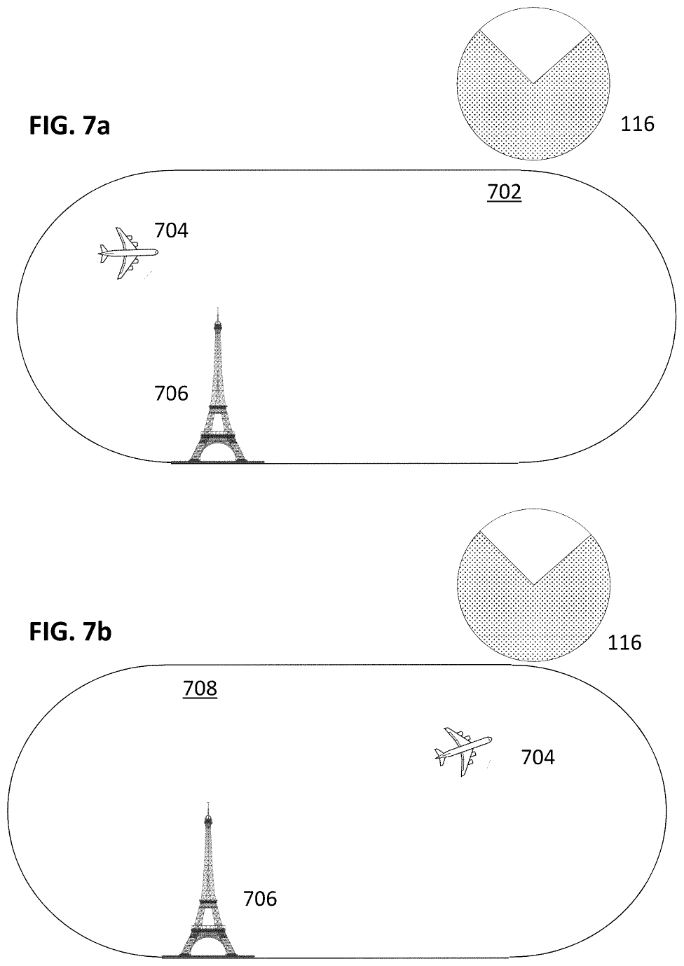

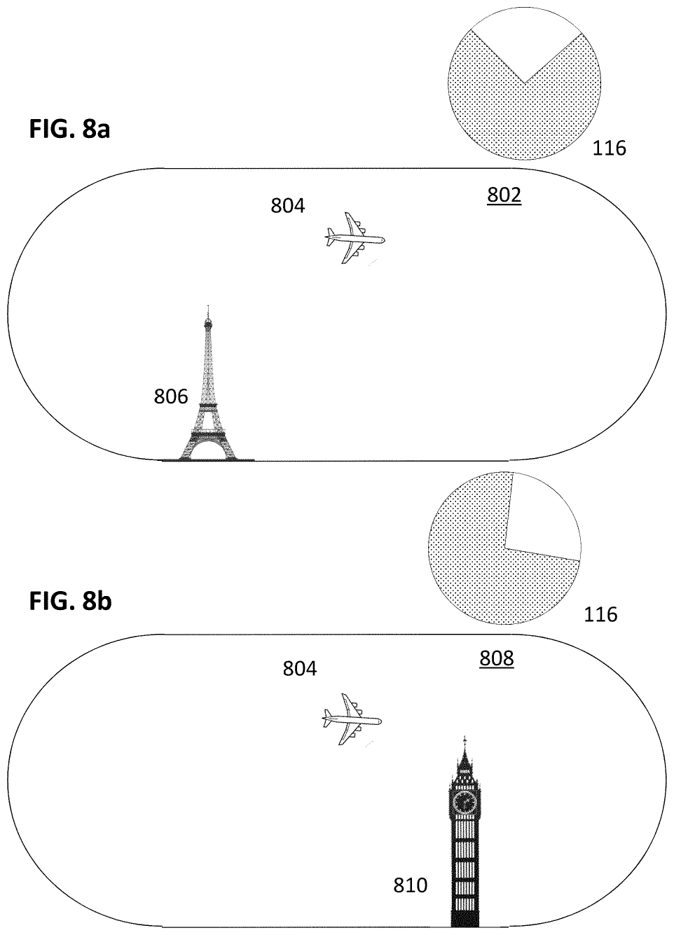

In an embodiment that takes into account the object movement rate ObMov, that is to say the change rate of the object coordinates in the fields of view, the importance score ImpSc may be as follows: ImpSc=A.OccNum+B.ViCh+C.ObMov where A, B and C are ponderation coefficients (e.g, integers). The importance score ImpSc may be positively or negatively correlated with the object movement rate ObMov (see for instance the combination of ObMov with ViCh described below). Any combination of OccNum, ViCh and ObMov may be used, provided they allows discrimination candidate object identifiers. A high importance score denotes a visual item (and its associated object) that presents a strong attraction to the user. Several examples will be detailed in FIGS. 7a, 7b, 8a and 8b.

In an embodiment, instead of an arithmetic formulation, a geometric formulation may be used, such as ImpSc=(OccNum.ViCh.)^{1/2} or ImpSc=(OccNum.ViCh.ObMov)^{1/3}.

The object movement rate ObMov may be particularly relevant in combination with the view change rate ViCh. A non-zero ViCh coupled with an almost zero ObMov means that the user is actively following the visual item in the XR environment. Therefore, the importance score may couple those two values: for instance, the importance score ImpSc may be defined as ImpSc=A.OccNum+(B.ViCh)/(C.ObMov), or as ImpSc=A.OccNum.B(ViCh)/(C.ObMov), where A, B and C are ponderation coefficients.

The importance score ImpSc may also be based on the occurrence number OccNum compared to an occurrence threshold (OccThr) in order to discriminate visual items that appear on a small number of fields of view from visual items that appear on many fields of view. The occurrence threshold may be, for instance, an integer between 5 and 300 or 1000. For example, a formula enhancing the difference between the occurrence number and the occurrence threshold may be used, such as ImpSc=A.(OccNum−OccThr)³+B.ViCh+C.ObMov. Elevating the difference to the an uneven power allows easily taking into account the sign of difference OccNum minus OCcThr, such that a candidate object identifier for which the occurrence number is far under the occurrence threshold OccThr is unlikely to have a high importance score ImpSc. Alternatively, the comparison to occurrence threshold OccThr may be performed before step 420, 422 and 424 or only before 424. In that case, steps 420, 422 and/or 424 are performed in response to determining that the occurrence number is higher than the occurrence threshold. This avoids performing calculations for an object identifier whose importance score ImpSc was going to be low.

In an embodiment, the importance score ImpSc may also be based on the object feature 518. For instance, control circuitry 304, when executing the score engine, may use a table, stored in storage 310, whereby a value ObjTy may be attributed to an object feature: for example, a car may have a higher object feature value ObjTy than grass. The importance score ImpSc may then be calculated as: ImpSc=A.OccNum+B.ViCh+D.ObjTy, where A, B and D are ponderation coefficient (e.g. positive integers). In a further embodiment, the table may depend on the user's profile or watching pattern: for instance, for a user who browses a lot of media content disparaging cars and a lot of media content celebrating bikes, the object feature value ObjTy may be low for a car and high for a bike.

The importance score formula may combine all the embodiments detailed above to obtain a more complex but more refined importance score enabling to an increased discrimination power.

As illustrated by the different formulas, the importance score may be defined as a scalar, which groups into a single number several parameters. It is also possible however to define an importance score as an n-uplet of values (for instance, a couple of values), to separately take into account one or several parameters disclosed previously or to gather the parameters in a different fashion. For instance, the importance could be defined as a vector, such as ImpSc=(A.(OccNum−OccThr)³, B.ViCh, C.ObMov, D.ObjTy). In that case, any comparison with the importance score entails using an appropriate order relation.

At 426, control circuitry 304, when executing a comparison engine, compares the importance score ImpSc to an importance threshold ImpThr. The importance threshold enables discriminating candidate object identifiers that are of interest to the user from other candidate object identifiers. An importance score ImpSc equal or above the importance threshold ImpThr means that the visual item associated with the candidate object identifiers is likely to have attracted the attention of the user. The higher the importance score, the higher the likelihood of attraction. The importance threshold ImpThr may be a positive integer, such as 80, 90 or 100. Typically, the importance threshold ImpThr is unitless (as exemplified with the importance score above). In an embodiment, the occurrence threshold OccThr is the highest value of the occurrence number amongst a plurality of object identifiers (for example, for object identifiers that all appear in a plurality of fields of view), such that only the object identifier with the highest importance score passes the importance threshold. The importance threshold ImpThr has the same nature as the importance score: an importance score as a scalar needs to be compared to a threshold as a scalar and an importance score as an n-uplet may be compared to a threshold as an n-uplet. With n-uplets, each parameter may be directly compared to a predetermined value of the importance threshold ImpThr.

When control circuitry 304, when executing the comparison engine, determines that the importance score ImpSc is below the importance threshold ImpThr, then the process goes back to step 416, and control circuitry 304, when executing the selection engine, selects another object identifier 506. When control circuitry 304, when executing the comparison engine, determines that the importance score ImpSc is equal or above the importance threshold ImpThr, then the process proceeds at 428.

At 428, control circuitry 304, when executing an instruction engine, generates instructions for displaying in the XR environment supplemental content. In an embodiment, the instructions are generated so that supplemental content is related to the visual item corresponding to candidate object identifier whose associated importance score was above the importance threshold. For instance, features 518 of the object 514 may be compared to a list of metadata on the supplemental content provider server 210, in order to select appropriate supplemental content. Alternatively, the supplemental content is not related to the features of the visual item.

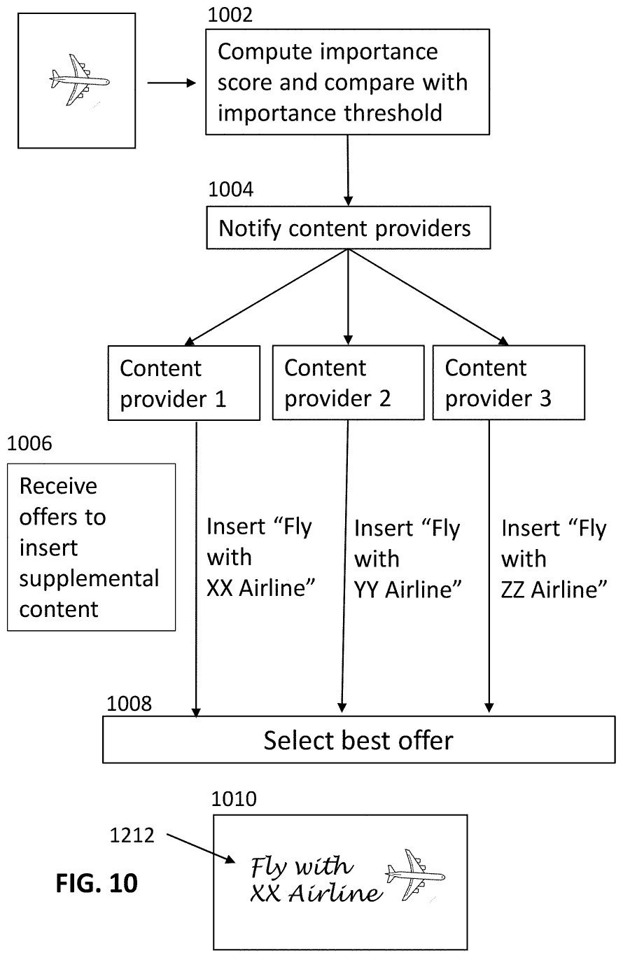

In response to the control circuitry 304 generating, when executing the instruction engine at 428, control circuitry 304, when executing a displaying engine, may retrieve, at 430, supplemental content from a supplemental content provider 210. Typically, the instructions may be sent by control circuitry 304, when executing the instruction engine, to a supplemental content provider server 210, and the supplemental content is received by control circuitry 304, when executing the displaying engine. Alternatively, to improve a reaction time of the system 200, a plurality of supplemental content items may have been previously provided by the supplemental content provider server 210 to the control circuitry 304, when executing the instruction engine, and stored in storage 310, so that control circuitry 304, when executing the displaying engine, may choose supplemental content based on criteria without referring to the supplemental content providers 210. For instance, as discussed above, the supplemental content may be chosen based on the object feature, for instance by matching metadata (e.g. one of the features itself, or metadata derived from the feature) from a list of metadata of the object to metadata from a list of metadata of a visual item of the supplemental content. In an embodiment, a bidding war may be carried out between different potential supplemental content providers for the supplemental content. The bidding war may include notifying said potential providers, launching the bidding war, determining a winner and retrieving supplemental content from the winning server. Again, the bidding war may be carried out by control circuitry 304, when executing the displaying engine, without referring to the supplemental content provider server. The bidding war will described in more detail in relation to FIG. 10.

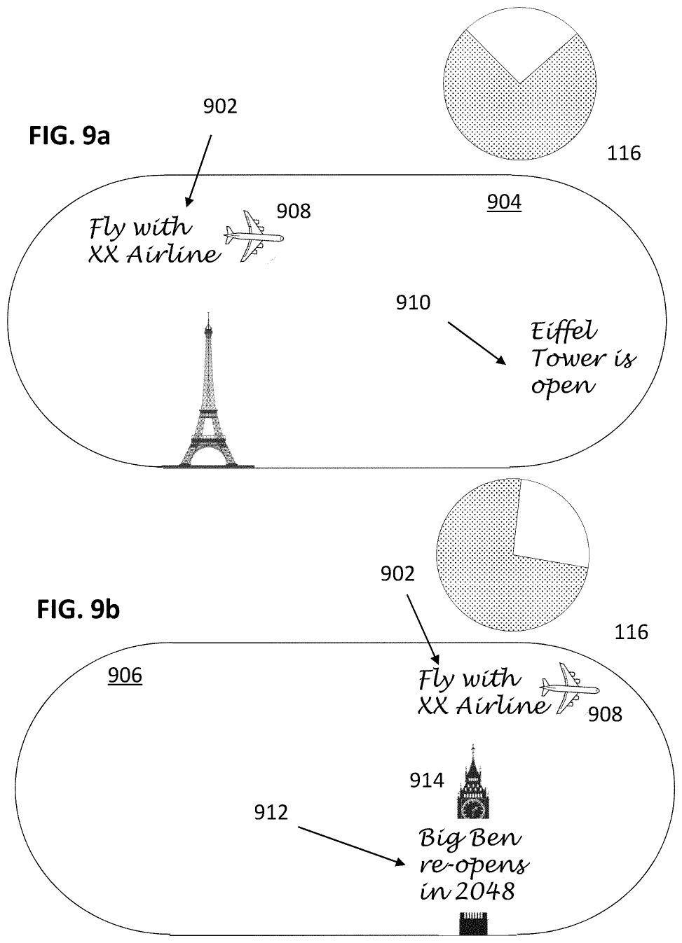

At last, control circuitry 304, when executing the displaying engine, displays, at 432, the supplemental content by means of the user equipment 202 and more specifically the XR set 204. FIGS. 9a and 9b provide several examples for displaying supplemental content.

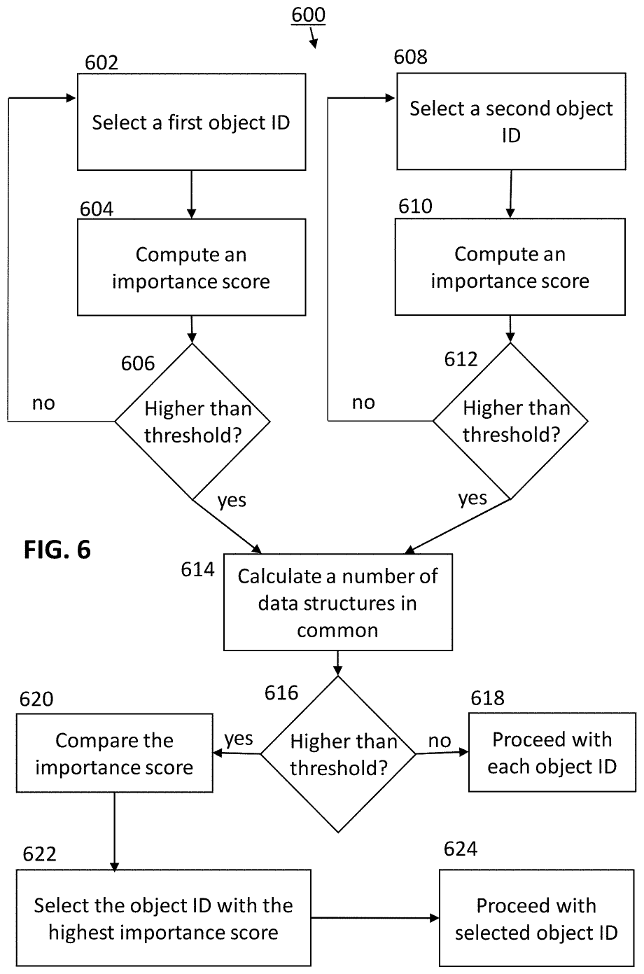

Process 500 may be run in parallel for different object identifiers. The case where there might be a conflict (e.g. two visual items appearing on the same field of view) is addressed in relation to FIG. 6.

FIG. 6 illustrates a flowchart addressing a situation where two visual items in a plurality of fields of view may be in competition. In an embodiment, control circuitry 304, when executing the selection engine, selects, at 602, a first candidate object identifier, and control circuitry 304, when executing the score engine, computes, at 604, an importance score and control circuitry 304, when executing the comparison engine, determines, at 606, that the importance score is higher than the importance threshold (not all steps have been illustrated here). The first candidate object identifier appears in a first plurality of data structures. Similarly, at 608, 610, 612, control circuitry 304 processed a second candidate object identifier, which appears in a second plurality of data structures. At 614, control circuitry 304, when executing a similarity engine (for instance implemented on computing device 206 or the computing server 208), calculates a number of shared data structures between the first and the second pluralities. At 616, control circuitry 304, when executing a comparison engine, compares the number to a similarity threshold. If control circuitry 304 determines that the number is lower than the similarity threshold, then there is no competition between the two visual items and the process may proceed, at 618, for each object identifier independently, as described in FIG. 4. If control circuitry 304 determines that the number of shared data structures is equal to or higher than the similarity threshold, then there is a risk of competition and it is preferable to display only one supplemental content. The similarity threshold may be, for instance, half of the lowest occurrence number of the first candidate object identifier and the second candidate object identifier (that is to say the lowest number of fields of view in which the first candidate object appears or in which the second candidate object appears). In response to determining that the number of shared data structures is equal to or higher than the threshold, at 620, control circuitry 304, when executing comparison engine, compares the respective importance scores of the first object identifier and the second object identifier. At 622, control circuitry 304, when executing a selection engine (for instance, implemented on computing device 206 or the computing server 208), selects the object identifier with the higher importance score of the two and, at 624, process proceeds with that selected candidate object identifier, as described in FIG. 4. The other candidate object identifier may be discarded.

FIGS. 7a, 7b, 8a, 8b, are aimed at illustrating different situations mentioned previously. In FIG. 7a, field of view 702 includes visual items 704 (feature: airplane) and 706 (feature: Eiffel Tower). In FIG. 7b, field of view 708 includes the same visual items 704 and 706. The occurrence number OccNum for each object identifier associated with the two visual items is 2. The field coordinates, represented by diagram 116, of the two fields of view are identical. Therefore, the view change rate ViCh is zero or close to zero (to account for negligible movements). Visual item 706 stays at the same position between field of view 702 and field of view 708, therefore the object movement rate ObMov associated with visual item 706 (Eiffel Tower) is zero or close to zero and the object movement rate ObMov associated with visual item 704 (airplane) is not zero. FIGS. 7a and 7b illustrate a situation where the user is static in the XR environment and there is a visual item moving within in the XR environment. Typically the importance score of the object identifier associated with visual item 704 may be higher than that of visual item 706, because of the values of ObMov. Conversely, given that feature “Eiffel Tower” may have a high value, the importance score of the object identifier associated with visual item 706 may be higher than that of visual item 704.

In FIG. 8a, field of view 802 includes visual items 804 (feature: airplane), 806 (feature: Eiffel Tower). In FIG. 8b, field of view 808 includes the same visual item 804 and new visual item 810 (feature: Big Ben). The occurrence number OccNum for each object identifier associated with the three visual items is respectively two (visual item 804), one (visual item 806) and one (visual item 810). The field coordinates 116 of the two fields of view are not identical this time. Therefore, view change rate ViCh is not zero. Visual item 804, however, stays at the same position between field of view 802 and field of view 808 (in the center of the fields of view), therefore the object movement rate ObMov associated with visual item 806 is zero or close to zero (again, to account for negligible movements). FIGS. 8a and 8b illustrate a situation where the user is actively following visual item 804 in the XR environment. As the occurrence number OccNum for objects related to visual items 706 and 710 is equal to 1, it may be considered that it is not above the occurrence threshold OccThr (e.g. 2). Therefore the objects cannot be considered objects of interest. Conversely, as the occurrence number OccNum for object related to visual item 804 is above the threshold, item 804 is associated with a candidate object identifier.

FIGS. 9a, 9b illustrates different embodiments to display the supplemental content. For instance, supplemental content 902 may follow in the fields of view 904, 906 a visual item 908 (diagram 116 illustrates different field coordinates for the fields of view 904, 906). For instance, supplemental content 910 may be located in an empty area of the field of view 904. For instance, supplemental content 912 may be laid over visual item 914 (with transparency or not) or, at a fixed location within any field of view, such as the bottom or a corner.

FIG. 10 illustrates a bidding war (or auction) to determine the supplemental content provider that is to be solicited for the supplemental content to be displayed. After control circuitry 304 has, at 1002, computed an importance score for an object identifier and determined that the importance score is above the importance threshold, control circuitry 304 notifies, at 1004, a plurality of supplemental content providers (e.g. content provider 1, content provider 2, content provider 3), for instance, via the emission of a notification to the respective supplemental content provider servers 210. The notification may include all the data of the object 514, in particular the object features 518, so that the supplemental content provider may decide to respond or not to the notification. The notification may also include the importance score of the object identifier. At 1006, control circuitry 304 receives offers from the different supplemental content providers, via the reception of respective requests from the respective supplemental content provider servers. An offer may comprise the supplemental content (“Fly with XX Airline”, “Fly with YY Airline”, etc.), a technical specification (size of the data, size of the display, duration of the display, etc.) and a financial aspect. At 1008, control circuitry 304 selects the best offer. The best offer may be decided based on any element of the offer and other criteria: size (in terms of data) of the supplemental content, size (in terms of display) of the supplemental content, duration of the display, compliance with a displaying policy (depending on the XR environment), financial compensation, etc. At 1010, control circuitry causes the selected supplemental content 1212 to be displayed.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for presenting supplemental content in an extended reality environment, the method comprising:
receiving, by a device, a plurality of fields of view of the extended reality environment, wherein each field of view of the plurality of fields of view was captured at a different time position;
generating a data stream representing the plurality of fields of view, the data stream comprising a respective data structure for each of the fields of view, wherein each respective data structure comprises:
at least one object identifier corresponding to a visual item appearing in a respective field of view of the plurality of fields of view, and
field coordinates representing the position of the respective field of view in the extended reality environment;
calculating a number of data structures in the data stream in which a same object identifier, called a candidate object identifier, appears;
calculating a measure of variance of field coordinates for the data structures in which the candidate object identifier appears;
computing an importance score for the candidate object identifier, based on (a) the calculated number of data structures in the data stream in which the candidate object identifier appears, and (b) the calculated measure of variance of coordinates for the data structures in which the candidate object identifier appears,
wherein the importance score measure is positively correlated with the measure of variance of field coordinates; and
in response to the importance score exceeding an importance threshold, generating instructions for displaying in the extended reality environment supplemental content, related to the visual item corresponding to the candidate object identifier.

2. The method of claim 1, wherein generating the data stream comprises:
identifying a visual item in the respective field of view; and
attributing an object identifier to the identified visual item, wherein a same visual item appearing in different respective fields of view is attributed the same object identifier.

3. The method of claim 1, wherein the importance score is based on the number of data structures in the data stream in which the candidate object identifier appears being higher than an occurrence threshold.

4. (canceled)

5. The method of claim 1, wherein:
each respective data structure of the data stream further comprises object coordinates representing the position of the visual item in the field of view, the visual item corresponding to the object identifier; and
the method further comprises:
calculating a measure of variance of object coordinates for the data structures in which the candidate object identifier appears,
wherein the importance score is further based on the calculated measure of variance of object coordinates.

6. The method of claim 5, wherein:
the importance score based on a measure of variance of field coordinates and a measure of variance of object coordinates is lower than the importance score based on a higher measure of variance of field coordinates and a lower measure of variance of object coordinates.

7. The method of claim 1, wherein the data stream further comprises, for each data structure:
an object feature, representing a feature of the visual item,
wherein the importance score is further based on the object feature.

8. The method of claim 1, wherein:
the candidate object identifier is a first candidate object identifier and the first candidate object identifier appears in a first plurality of data structures; and
an importance score has been computed for a second candidate object identifier appearing in a second plurality of data structures, wherein the importance score of the second candidate object identifier exceeds the importance threshold;
the method further comprising:
calculating a number of shared data structures between the first and the second pluralities;
in response to determining that the number is higher than a similarity threshold, selecting the candidate object identifier that has the higher importance score of the two; and
generating instructions for displaying in the extended reality environment supplemental content, related to the visual item corresponding to the selected candidate object identifier.

9. The method of claim 1, further comprising:
notifying a plurality of potential content providers for the supplemental content;
launching a bidding war amongst the plurality of content providers;
determining a winner to the bidding war, wherein the supplemental content is provided by the winner of the bidding war.

10. The method of claim 1, wherein the data stream further comprises, for each data structure:
object metadata associated with the object; and
wherein retrieving content related to the object comprises retrieving content that is associated with the object metadata.

11. A system for presenting supplemental content in an extended reality environment, the system comprising:
control circuitry configured to: receive, by a device, a plurality of fields of view of the extended reality environment, wherein each field of view of the plurality of fields of view was captured at a different time position;
generate a data stream representing the plurality of fields of view, the data stream comprising a respective data structure for each of the fields of view, wherein each respective data structure comprises:
at least one object identifier corresponding to a visual item appearing in a respective field of view of the plurality of fields of view, and
field coordinates representing the position of the respective field of view in the extended reality environment;
calculate a number of data structures in the data stream in which a same object identifier, called a candidate object identifier, appears;
calculate a measure of variance of field coordinates for the data structures in which the candidate object identifier appears;
compute an importance score for the candidate object identifier, based on (a) the calculated number of data structures in the data stream in which the candidate object identifier appears, and (b) the calculated measure of variance of coordinates for the data structures in which the candidate object identifier appears,
wherein the importance score measure is positively correlated with the measure of variance of field coordinates; and
in response to the importance score exceeding an importance threshold, generate instructions for displaying in the extended reality environment supplemental content, related to the visual item corresponding to the candidate object identifier.

12. The system of claim 11, wherein control circuitry configured to generate the data stream comprises control circuitry configured to:
identify a visual item in the respective field of view; and
attribute an object identifier to the identified visual item, wherein a same visual item appearing in different respective fields of view is attributed the same object identifier.

13. The system of claim 11, wherein the importance score is based on the number of data structures in the data stream in which the candidate object identifier appears being higher than an occurrence threshold.

14. (canceled)

15. The system of claim 11, wherein:
each respective data structure of the data stream further comprises object coordinates representing the position of the visual item in the field of view, the visual item corresponding to the object identifier; and,
the control circuitry being further configured to:
calculate a measure of variance of object coordinates for the data structures in which the candidate object identifier appears,
wherein the importance score is further based on the calculated measure of variance of object coordinates.

16. The system of claim 15, wherein the importance score based on a measure of variance of field coordinates and a measure of variance of object coordinates is lower than the importance score based on a higher measure of variance of field coordinates and a lower measure of variance of object coordinates.

17. The system of claim 11, wherein the data stream further comprises, for each data structure:
an object feature, representing a feature of the visual item,
wherein the importance score is further based on the object feature.

18. The system of claim 11, wherein:
the candidate object identifier is a first candidate object identifier and the first candidate object identifier appears in a first plurality of data structures; and
an importance score has been computed for a second candidate object identifier appearing in a second plurality of data structures, wherein the importance score of the second candidate object identifier exceeds the importance threshold;
the control circuitry being further configured to:
calculate a number of shared data structures between the first and the second pluralities;
in response to determining that the number is higher than a similarity threshold, select the candidate object identifier that has the higher importance score of the two; and
generate instructions for displaying in the extended reality environment supplemental content, related to the visual item corresponding to the selected candidate object identifier.

19. The system of claim 11, wherein the control circuitry is further configured to:
notify a plurality of potential content providers for the supplemental content;
launch a bidding war amongst the plurality of content providers;
determine a winner to the bidding war, wherein the supplemental content is provided by the winner of the bidding war.

20. The system of claim 11, wherein the data stream further comprises, for each data structure:
object metadata associated with the object; and
wherein retrieving content related to the object comprises retrieving content that is associated with the object metadata.

21-50. (canceled)
